(19) United States
(12) Patent Application Publication
(10) Pub. No.: US 2017/0374496 A1
(43) Pub. Date: Dec. 28, 2017

(54) IDENTIFICATION OF USERS IN A PREDEFINED ENVIRONMENT

(71) Applicant: Orange, Paris (FR)

(72) Inventors: Bruno Lemoine, Caen (FR); Tiphaine Marie, St. Contest (FR)

(21) Appl. No.: 15/629,252

(22) Filed: Jun. 21, 2017

(30) Foreign Application Priority Data
Jun. 22, 2016 (FR) 1655797

(51) Int. Cl. H04W 4/00; H04L 12/26; H04B 5/00

(52) U.S. Cl. CPC H04W 4/008; H04B 5/0031; H04L 43/045

(57) ABSTRACT

A method is provided for obtaining a graph by a terminal able to communicate with an item of equipment via a telecommunications network. The method is adapted to obtain a medium identifier emitted, via a near-field wireless communication technology, by a data medium situated in a predefined environment, to dispatch to the item of equipment a notification signaling the presence of the user in the environment, to receive identification data in respect of users present and at least one item of position information, and to highlight on a displayed graph at least one position allocated to a user and to display on said graph, in conjunction with a highlighted position, data of the user. Also provided are a method of presence management adapted to receive presence notifications and to transmit to the terminal identification data in respect of users present in the environment. Also provided are the terminal and equipment.

### CROSS-REFERENCE TO RELATED APPLICATIONS

This application claims priority to and the benefit of French Patent Application No. 1655797, filed Jun. 22, 2016, the content of which is incorporated herein by reference in its entirety.

### FIELD OF THE DISCLOSURE

The present disclosure lies in the field of the identification of people meeting in a predefined environment.

### BACKGROUND OF THE DISCLOSURE

Knowing the actual participants at a meeting is paramount. In physical meetings, this generally entails going around the table, often at the instigation of the organizer of the meeting.

However, even if he is attentive, a user might not remember a name or understand a name poorly or possibly not hear it.

He may also arrive late and not be present when the table is being gone around.

Also, the organizer frequently does not propose that the table be gone around.

Identifying the participants in a meeting may be significant for a participant. This may enable him to adapt what he says or to keep in contact with another participant after the meeting.

Conversely, not recalling or not having heard the identity of a participant may create an impediment in the course of the meeting.

Moreover, going around the table in this way may turn out to be lengthy and tedious especially when the number of participants is significant.

### SUMMARY

An aspect of the disclosure relates to a method of obtaining a graph by a telecommunication terminal of a user, said terminal being able to communicate with an item of equipment via a telecommunications network.

According to an exemplary embodiment, the method comprises the following steps, implemented by said terminal:
obtaining of a medium identifier emitted by a data medium able to emit data via a near-field wireless communication technology, said medium being situated in a predefined environment;
dispatching to said item of equipment of a notification signaling the presence of the user in the predefined environment, said notification containing said medium identifier obtained and an identifier of the user or of the terminal;
reception, subsequent to the dispatching of said notification, from said item of equipment, of data relating to at least one user present in said environment, said data comprising identification data in respect of at least one user present and at least one item of position information;
display of a graph representing a plurality of positions of users in said predefined environment;
highlighting on the graph of at least one position of the plurality of positions, said at least one position being allocated to at least one user of the plurality as a function of said at least one item of position information; and
display on said graph, in conjunction with at least one highlighted position, of all or part of the data received for at least one user.

Data media designed to emit data via a near-field wireless technology, for example a radio technology, are disposed in a predefined environment.

When it is situated in proximity to one of the data media, a terminal of a user receives the data emitted by the medium. More precisely, it thus gathers an identifier of this data medium.

The dispatching of a notification by the terminal signals the presence of the user in the environment.

The notification comprises a data medium identifier and an identifier of the user or of a terminal of the user.

The user identifier or user terminal identifier allows the item of equipment receiving this notification to obtain identification data in respect of the user.

The medium identifier allows this item of equipment to obtain an item of information about the position occupied by the user.

This item of position information makes it possible to pinpoint this user in the environment.

After having signaled his presence, the user receives from the item of equipment data allowing him to highlight on a predefined graph, the position of the users present and to associate with these positions identification data, such as for example a name.

The display of this graph on a screen of his terminal allows him to identify the various people present in the same environment as him.

According to a particular embodiment of the obtaining method, said at least one item of position information is an item of relative position information.

The item of relative position information defines the positions of the users with respect to one another. This is a simple means of locating the users in an environment. This avoids using locating techniques and means such as a GPS (for ‘Global Positioning System’).

According to a particular embodiment of the obtaining method, the data relating to at least one user present in said environment comprise an ordered sequence of users' identification data.

In this embodiment, the item of position information is given by the order of the sequence. The order of the data of users in the sequence corresponds to an order of the users in the environment. It is thus easy to reproduce this order on a graph.

According to a particular embodiment of the obtaining method, the sequence contains data signaling at least one unoccupied position.

The signaling of the unoccupied places makes it possible to distribute the users on the graph more precisely.

According to a particular embodiment of the obtaining method, said at least one item of position information comprises at least one reference to a predetermined position of said graph.

This embodiment requires that the item of equipment knows the references of positions on the graph but it allows the item of equipment to inform the terminal of at least one precise location of at least one user on the graph.

According to a particular embodiment of the obtaining method, the data relating to at least one user present in said environment comprise a list of pairs, a pair of the list containing identification data in respect of a said user present and a position identifier.

In this embodiment, each user present is associated with an item of information making it possible to define the location of this user on the graph.

According to a particular embodiment, the method comprises a step of dispatching to said item of equipment a notification signaling the departure of said user from the environment. The notification contains an identifier of said user or of said terminal.

The dispatching of a notification signaling the departure of a user allows the item of equipment to be informed that this user is no longer present in the environment. The item of equipment thus knows at any instant the list of users present in the environment. It can then dispatch updated presence data to the other terminals that are still present in the environment.

According to a particular embodiment of the obtaining method, the steps of reception, highlighting and display are repeated.

The repeating of these steps allows an updating of the graph. This is particularly useful when a new user signals his presence for example in case of late arrival in the environment, or signals his departure from the environment.

The disclosure also pertains to a method of presence management.

According to an exemplary embodiment, the method of presence management comprises the following steps, implemented by an item of equipment able to communicate with a plurality of terminals via a telecommunication network:
reception, from at least one terminal of the plurality, of at least one notification signaling the presence of a user in a predefined environment, a said notification containing a medium identifier of a predefined list of medium identifiers for said environment and an identifier of said user or of a terminal of said user, said medium identifier being emitted by a data medium able to emit data via a near-field wireless communication technology, said list of medium identifiers containing at least one item of position information;
obtaining, for at least one presence notification received, of identification data in respect of said user of said terminal;
transmission to said at least one terminal, of data relating to at least one user present in said environment, said data comprising said identification data and at least one item of position information.

Presence signaling notifications emitted by several terminals situated in one and the same environment are collected by one and the same item of equipment.

Together, these items of information allow this item of equipment to provide the various terminals with data making it possible to display on a graph representing the environment, the position of the various terminals and consequently of the users of these terminals.

Identification data displayed in conjunction with a position make it possible to identify the user situated at this position.

The disclosure further pertains to a terminal of a user, said terminal being able to communicate with an item of equipment via a telecommunications network.

According to an exemplary embodiment, this terminal comprises:
a near-field communication module designed to obtain a medium identifier emitted by a data medium able to emit data via a near-field wireless communication technology, said medium being situated in a predefined environment;
a module for dispatching to said item of equipment a notification signaling the presence of said user in a predefined environment, said notification containing said medium identifier obtained and an identifier of the user or of the terminal;
a module for receiving, subsequent to the dispatching of said notification, from said item of equipment, the data relating to at least one user present in said environment, said data comprising identification data in respect of at least one user present and at least one item of position information;
a display module configured to display a graph representing a plurality of positions of users in said predefined environment, configured to highlight on said graph at least one position of the plurality of positions, said at least one position being allocated to at least one user of the plurality as a function of said at least one item of position information, and configured to display on said graph, in conjunction with at least one highlighted position, all or part of the data received for at least one user.

The disclosure also pertains to an item of equipment able to communicate with a plurality of terminals via a communication network comprising:
a reception module configured to receive, from at least one terminal of the plurality, at least one notification signaling the presence of a user in a predefined environment, a said notification containing a medium identifier of a predefined list of medium identifiers for said environment and an identifier of said user or of a terminal of said user, said medium identifier being emitted by a data medium able to emit data via a near-field wireless communication technology, said list of medium identifiers containing at least one predefined position information item;
a module for obtaining, for at least one presence notification received, identification data in respect of said user of said terminal;
a module for transmitting to said at least one terminal, the data relating to at least one user present in said environment, said data comprising said identification data and at least one item of position information.

The disclosure also pertains to a system comprising an item of equipment such as described above and a plurality of terminals such as described above.

The terminals and the item of equipment as well as the system benefit from the same advantages cited above as the obtaining method and the method of presence management.

The disclosure also pertains to a computer program product comprising instructions for the implementation of an obtaining method such as described above, when this program is executed by a processor.

The disclosure also pertains to a computer program product comprising instructions for the implementation of a method of presence management such as described above, when this program is executed by a processor.

The disclosure further pertains to an information medium readable by a data processor, and comprising instructions for the implementation of an obtaining method such as described above.

The disclosure finally pertains to an information medium readable by a data processor, and comprising instructions for the implementation of a management method such as described above.

The disclosure thus relates to a software package or program, liable to be executed by a computer or by a data processor, this software package/program comprising instructions for controlling the execution of the steps of an obtaining method or of a management method. These instructions are intended to be stored in a memory of a computing device, loaded and then executed by a processor of this computing device.

This software package/program can use any programming language, and be in the form of source code, object code, or of code intermediate between source code and object code, such as in a partially compiled form, or in any other desirable form.

The computing device can be implemented by one or more physically distinct machines and exhibits overall the architecture of a computer, including constituents of such an architecture: data memory(ies), processor(s), communication bus, hardware interface(s) for connecting this computing device to a network or another item of equipment, user interface(s), etc.

The disclosure also relates to an information medium readable by a data processor, and comprising instructions of a program such as mentioned hereinabove. The information medium can be any entity or device capable of storing the program.

### BRIEF DESCRIPTION OF THE DRAWINGS

Other particularities and advantages of the present disclosure will become apparent in the following description of an embodiment given by way of non-limiting example, with reference to the appended drawings, in which:

FIG. 1 is a diagram illustrating a system according to one embodiment of the disclosure,

FIG. 2 is a flowchart illustrating the various steps of a method of obtaining a graph and of a method of presence management according to one embodiment of the disclosure,

FIG. 3 is a diagram representing a first graph according to one embodiment of the disclosure,

FIG. 4 is a diagram representing the first graph in which positions are highlighted, according to a first exemplary embodiment,

FIG. 5 is a diagram representing the first graph in which positions are highlighted, according to a second exemplary embodiment,

FIG. 6 is a diagram representing a second graph according to one embodiment of the disclosure,

FIG. 7 is a diagram representing an item of equipment able to implement a management method according to one embodiment of the disclosure,

FIG. 8 is a diagram representing a terminal able to implement an obtaining method according to one embodiment of the disclosure.

### DETAILED DESCRIPTION OF ILLUSTRATIVE EMBODIMENTS

An exemplary embodiment of the disclosure is implemented by means of software components and/or hardware components. In this regard, the term “module” can correspond in this document either to a software component, or to a hardware component or to a set of hardware and/or software components, able to implement a function or a set of functions, according to what is described hereinbelow for the module concerned.

A software component corresponds to one or more computer programs, one or more subprograms of a program, or more generally to any element of a program or of a software package. A software component such as this is stored in memory and then loaded and executed by a data processor of a physical entity (terminal, server, gateway, set-top-box, router, etc.) and is able to access the hardware resources of this physical entity (memories, recording media, communication buses, electronic input/output cards, user interfaces, etc.).

In the same manner, a hardware component corresponds to any element of a hardware set. It may be a programmable hardware component or with integrated processor for the execution of software, for example an integrated circuit, a chip card, an electronic card for the execution of firmware, etc.

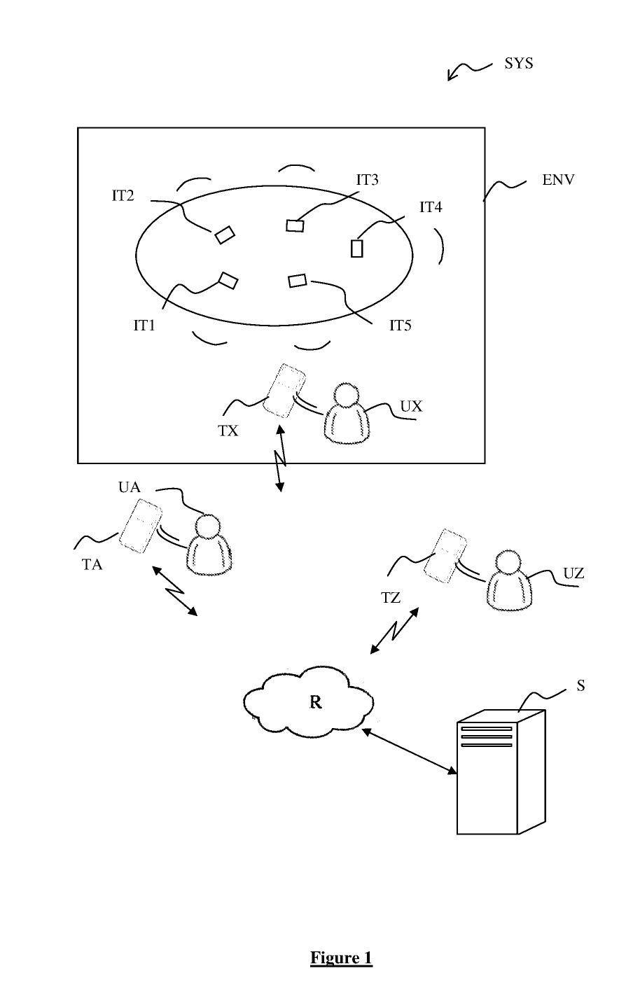

An embodiment of a method of obtaining a graph and of a method of presence management will now be described with reference to FIGS. 1 to 5.

With reference to FIG. 1, a plurality of data media, here data media IT1, IT2, IT3, IT4 and IT5 are distributed in a predefined environment ENV.

The data media are for example RFID (Radio Frequency Identification′) tags.

More generally, such a data medium is a device able to emit data via a near-field wireless communication technology.

No limitation is attached to the number of data media.

The environment ENV is for example a meeting hall in which seats are installed around a table and the tags are disposed on the table, facing a seat.

The position of the tags is defined beforehand. The system SYS represented in FIG. 1 comprises an item of equipment S and a plurality of terminals of users able to communicate with the item of equipment S via a telecommunications network R.

The terminals of users are for example a terminal TA of a user UA, a terminal TX of a user UX and a terminal TZ of a user UZ.

The terminals TA, TX and TZ are mobile terminals, for example mobile telephones, tablets, etc.

The network R is for example a mobile network.

By way of alternative, the telecommunication network R is the Internet network, an Intranet network, a wireless network of Wifi or Bluetooth type, etc.

The item of equipment S is an item of equipment able to communicate with the terminals via the network R. The item of equipment S is for example a server, a computer, a mobile telephone, etc.

In the embodiment described, the item of equipment S is situated outside of the environment ENV.

By way of alternative, the item of equipment S is situated in the environment ENV.

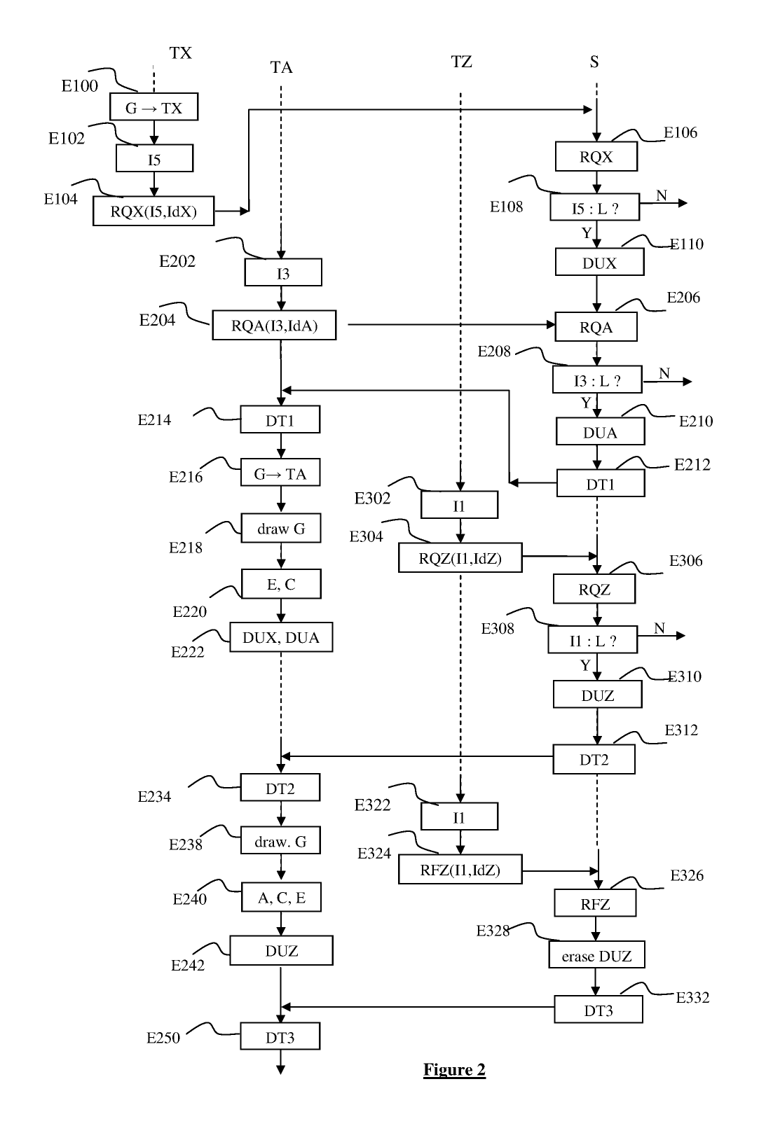

A particular embodiment of an obtaining method and of a method of presence management implemented in the system SYS will now be detailed with reference to FIG. 2.

During a prior initialization phase, a list L containing the identifiers of tags I1, I2, I3, I4 and I5 of the tags IT1, IT2, IT3, IT4 and IT5 positioned in the environment ENV is recorded.

The list L of identifiers of tags is a list ordered as a function of the position of the tags in the environment ENV.

The order of the list L represents an item of position information within the meaning of the disclosure.

Also, during a prior phase, a graph G representing positions A, B, C, D and E in the environment ENV is defined.

The positions A to E represent on the graph G, the positions of the tags IT1 to IT5 in the environment ENV.

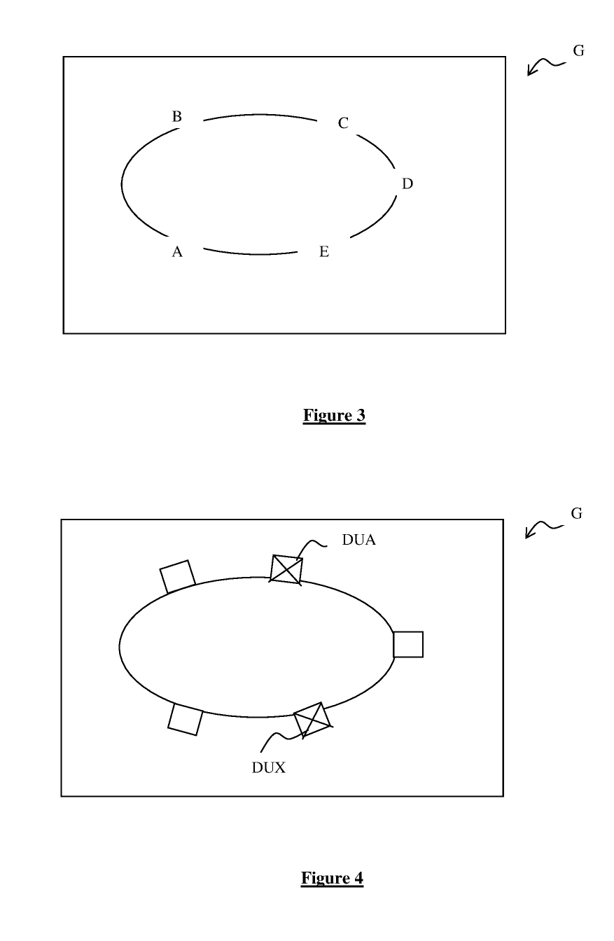

FIG. 3 is a diagram representing the graph G.

During a prior step E100, the terminal TX obtains the graph G and records it in a memory of the terminal TX.

The graph G is for example transmitted to the terminal TX by the item of equipment S or downloaded by the terminal TX, from a dedicated Internet site.

During a step E102, the user UX equipped with the terminal TX enters the environment ENV and sits on a seat facing the tag IT5. He presents his terminal TX in the vicinity of the tag IT5 and obtains the identifier I5 of the tag IT5.

During a step E104, the terminal TX dispatches a notification RQX destined for the item of equipment S via the communication network R. The notification RQX contains the tag IT5 identifier I5 obtained by the terminal TX and an identifier IdX of the terminal TX of the user UX.

The terminal identifier IdX is for example the MSISDN (‘Mobile Station International Subscriber Directory Number’) number of the terminal TX or the telephone number associated with the terminal TX.

By way of alternative, the identifier IdX is an identifier of the user UX, for example the name of the user UX, an identifier allocated to the user UX, for example within a company in which he works, a social security number, etc.

The identifier IdX has been recorded beforehand in a memory of the terminal TX.

The notification RQX is a message allowing the terminal TX to signal the presence of the user UX in the environment ENV.

The notification RQX is for example transmitted in the form of an SMS (for “Short message Service” in English).

By way of alternative, the notification RQX is a voice message, a mail, a message transmitted via instant messaging, etc.

The notification RQX is received by the item of equipment S during a step E106.

During a step E108, the item of equipment S verifies that the tag identifier I5 contained in the notification RQX figures in the list L.

In the case where the tag identifier received does not figure in the list L, the process stops. The terminal TX does not receive any response to the notification RQX or receives a message indicating to it that the tag is not recorded. In this case, the item of equipment S for example places itself on standby awaiting a new notification from a terminal.

By way of alternative, several lists of identifiers of tags have been prerecorded in a memory of the item of equipment S and during step E108, the item of equipment S searches for the tag identifier received from among several lists.

In the case where the tag identifier received figures in the list L, step E108 is followed by a step E110 during which the item of equipment S obtains data DUX relating to the user UX. Such data relating to the user UX contain identification data DIX in respect of the user UX, that is to say data allowing other users to identify the user UX, typically a name, a name and a forename, a photo, etc. The data DUX can also comprise complementary data DCX in respect of the user such as for example a company name, an address, a service name, etc.

The data DUX are for example obtained by the item of equipment S by consulting one or more databases, for example one or more directories, such as for example a company directory.

By way of alternative, all or part of these data DUX relating to the user UX are contained in the notification RQX received by the item of equipment S during step E106 or transmitted by the terminal TX to the item of equipment S in response to a request of the item of equipment S.

The data DUX are for example recorded in the list L in association with the tag identifier I5.

During a step E202, similar to step E102, the user UA equipped with the terminal TA sits on a seat facing the tag IT3. He presents his mobile terminal TA in the vicinity of the tag IT3 and obtains an identifier I3 of the tag IT3.

During a step E204, similar to step E104, the terminal TA dispatches a notification RQA destined for the item of equipment S via the communication network R. The notification RQA contains the tag IT3 identifier I3 obtained by the terminal TA and an identifier IdA of the user UA or of the terminal TA of the user UA.

The notification RQA is received by the item of equipment S during a step E206, similar to step E106.

During a step E208, similar to step E108, the item of equipment S verifies that the tag identifier I3 contained in the notification RQA figures in the list L.

In the case where the tag identifier received does not figure in the list L, the process stops.

In the case where the tag identifier received figures in the list L, step E208 is followed by a step E210, similar to step E110, during which the item of equipment S obtains data DUA relating to the user UA. Such data relating to the user UA contain identification data DIA in respect of the user UA.

The data DUA are for example recorded in the list L in association with the tag identifier I3.

During a step E212, the item of equipment S dispatches data DT1 to the terminal TA.

The data DT1 are data relating to at least one user who has signaled his presence in the environment ENV. The data DT1 comprise identification data in respect of at least one user present in the environment ENV and at least one item of position information.

In the embodiment described, the users who have signaled their presence being the users UX and UA, the data DT1 comprise the data DUX and DUA.

In the embodiment described, the item of position information is given by the order in which the data relating to the users, typically the identification data, are positioned in the data DT1. The positions on the graph G are relative positions of the users, that is to say positions determined with respect to one another.

In the embodiment described, the data DT1 also comprise an item of information about the unoccupied positions of the environment ENV.

The data DT1 transmitted are for example V, V, DUA, V, DUX.

The data V, V, DUA, V, DUX represents an ordered sequence within the meaning of an exemplary embodiment of the disclosure.

The ordering of the sequence represents an item of position information within the meaning of an exemplary embodiment of the disclosure.

V is here an exemplary item of information signaling an unoccupied position or more precisely, a position for which the item of equipment S has not received any presence signaling notification.

The ordered sequence V, V, DUA, V, DUX indicates here implicitly that the positions corresponding to the tags IT1 and IT2 are unoccupied, that the position corresponding to the tag IT3 is occupied by a user whose identification data are DUA, that the position corresponding to the tag IT4 is unoccupied and that the position corresponding to the tag IT5 is occupied by a user whose identification data are DUX.

The data DT1 are for example transmitted in the form of a message of SMS type.

The data DT1 can also be transmitted to the terminal TX.

The data DT1 are received by the terminal TA during a step E214.

During a step E216, the terminal TA obtains the graph G and records it in a memory of the terminal TA.

The graph G is for example transmitted to the terminal TA by the item of equipment S.

By way of alternative, the graph G is obtained by the terminal TA before reception of the data DT1.

No limitation is attached to the step of obtaining the graph G by the terminal TA.

During a step E218, the terminal TA displays the graph G recorded beforehand.

The graph G represents positions of users A, B, C, D, E in the environment ENV.

During a step E220, the terminal TA highlights on the graph G, the position C of the user UA and the position E of the user UX.

More precisely, the terminal TA deduces from the ordered sequence DT1 received that the first position A is not occupied, that the position B is not occupied, that the position C is occupied by the user UA, that the position D is not occupied and that the position E is occupied by the user UX.

FIG. 4 represents the graph G on which the positions of the users UA and UX are highlighted. In this diagram, an unoccupied position is represented by an empty square and an occupied position is represented by a square containing a cross.

In the embodiment described where the item of position information is given by the order of the data of the users, the positions on the graph are relative positions of the users, that is to say positions determined with respect to one another.

In the embodiment described, it is considered that the first element of the sequence DT1 received corresponds to the position A.

By way of alternative, the graph G being of closed form, the terminal TA allocates the position E to the user UA and highlights the position E on the graph G. The terminal TA thereafter allocates the other elements of the sequence DT1 as a function of the position of the user UA. Thus, the user UX will be positioned on the graph G, two places to the left of the user UA, that is to say in position B. This representation allows the user to rapidly identify the other people present.

During a step E222, the data DUX contained in the sequence DT1 received are displayed on the graph G in conjunction with the position E and the data DUA contained in the sequence DT1 received are displayed on the graph G in conjunction with the position C.

By way of alternative, just a part of the data DUX and/or of the data DUA received are displayed. The decision to display only a part of the data can be taken by the terminal TA for example as a function of the size of the screen on which the graph G is displayed and/or as a function of the number of occupied positions.

Subsequently, during a step E302, similar to step E102, a third user UZ equipped with a terminal TZ sits on a seat facing the tag IT1. He presents his mobile terminal TZ in the vicinity of the tag IT1 and obtains an identifier I1 of the tag IT1.

During a step E304, similar to step E104, the terminal TZ dispatches a notification RQZ destined for the item of equipment S via the communication network R. The notification RQZ contains the tag IT1 identifier I1 obtained by the terminal TZ and an identifier IdZ of the user UZ or of the terminal TZ of the user UZ.

The notification RQZ is received by the item of equipment S during a step E306, similar to step E106.

During a step E308, similar to step E108, the item of equipment S verifies that the tag identifier I1 contained in the notification RQZ figures in the list L.

In the case where the tag identifier received figures in the list L, step E308 is followed by a step E310, similar to step E110, during which the item of equipment S records in the list L, data DUZ relating to the user UZ.

During a step E312, similar to step E212, the item of equipment S dispatches data DT2 to the terminal TA.

The data DT2 comprise data relating to at least one user who has signaled his presence in the environment ENV. The data DT2 comprise identification data in respect of at least one user present in the environment ENV and at least one item of position information.

In the embodiment described, the users who have signaled their presence being the users TX, TA and TZ, the data DT2 comprise the data DUX, DUA and DUZ.

In the embodiment described, the data DT2 also comprise an item of information about the unoccupied positions of the environment ENV.

The data DT2 transmitted are for example DUZ, V, DUA, V, DUX.

The data DUZ, V, DUA, V, DUX represents an ordered sequence within the meaning of an exemplary embodiment of the disclosure.

The ordering of the sequence represents an item of position information within the meaning of an exemplary embodiment of the disclosure.

V is here an exemplary item of information signaling an unoccupied position or a position for which the item of equipment S has not received any presence signaling notification.

The ordered sequence DUZ, V, DUA, V, DUX indicates here implicitly that the position corresponding to the tag IT1 is occupied by a user whose identification data are DUZ, that the position corresponding to the tag IT2 is unoccupied, that the position corresponding to the tag IT3 is occupied by a user whose identification data are DUA, that the position corresponding to the tag IT4 is unoccupied and that the position corresponding to the tag IT5 is occupied by a user whose identification data are DUX.

The data DT2 are for example transmitted in the form of a message of SMS type.

The data DT2 can also be transmitted to the terminal TX and to the terminal TZ.

The data DT2 are received by the terminal TA during a step E234.

During a step E238, the terminal TA displays the graph G.

During a step E240, the terminal TA highlights on the graph G, the position A, the position C and the position E.

More precisely, the terminal TA deduces from the ordered sequence DT2 received that the first position A is occupied by the user UZ, that the position B is not occupied, that the position C is occupied by the user UA, that the position D is not occupied and that the position E is occupied by the user UX.

FIG. 5 is a diagram representing the graph G on which the positions A, C and E are highlighted.

In FIG. 5, an unoccupied position is represented by an empty square and an occupied position is represented by a square containing a cross.

In the embodiment described, it is considered that the first element of the sequence DT2 received corresponds to the position A.

During a step E242, the data DUZ contained in the sequence DT2 are displayed on the graph G in conjunction with the position A, the data DUX contained in the sequence DT2 are displayed on the graph G in conjunction with the position E and the data DUA contained in the sequence DT2 are displayed on the graph G in conjunction with the position C.

By way of alternative, the graph G with the positions C and E highlighted and the data DUX and DUA displayed remains displayed subsequent to step E222. In this alternative, it is not necessary to display the graph G again and the highlighting step E240 consists for the terminal TA in highlighting on the graph G the position A of the user UZ. The position E and the position C that were highlighted during step E220 remain in this state. Likewise, during the step E242 of displaying the identification data, just the data DUZ contained in the sequence DT2 are displayed on the graph G in conjunction with the position A, the data DUX and DUA remaining displayed. Steps E240 and E242 are then steps of updating of the graph G.

Subsequently, during a step E322, similar to step E302, the user UZ equipped with the terminal TZ envisages leaving the environment ENV. He presents his mobile terminal TZ in the vicinity of the tag IT1 and obtains the identifier I1 of the tag IT1 again.

The execution of step E322, that is to say the obtaining of the tag identifier by the terminal TZ, triggers the execution of a step E324 during which the terminal TZ dispatches a notification RFZ destined for the item of equipment S via the communication network R. The notification RFZ signals the departure of the user UZ from the environment ENV. The notification RFZ contains the identifier I1 of the tag IT1 and the identifier IdZ of the user UZ or of the terminal TZ of the user UZ.

As a variant, the notification RFZ does not contain the tag identifier IL

Also as a variant, the dispatching of the notification RFZ is triggered by an action of the user in relation to the terminal TZ, for example a selecting of a predefined command in a menu.

The notification RFZ is received by the item of equipment S during a step E326.

During a step E328, the item of equipment S deletes from the list L, the data DUZ relating to the user UZ.

During a step E332, similar to step E212, the item of equipment S dispatches data DT3 to the terminal TA.

The data DT3 comprise data relating to at least one user who has signaled his presence in the environment ENV and has not yet signaled his departure from the environment ENV. The data DT3 comprise identification data in respect of at least one user present in the environment ENV and at least one item of position information.

In the embodiment described, the users present being the users TX and TA, the data DT3 comprise the data DUX and DUA.

The data DT3 transmitted are for example V, V, DUA, V, DUX.

V is here an exemplary item of information signaling an unoccupied position.

The data DT3 can also be transmitted to the terminal TX.

The data DT3 are received by the terminal TA during a step E250.

Subsequent to the reception of the data DT3, the terminal TA updates the graph G in a similar manner to that described above.

In the embodiment described, the data DT1 received by the terminal TA are V, V, DUA, V, DUX and the data DT2 received by this same terminal are DUZ, V, DUA, V, DUX.

As an alternative, the data DT2 transmitted to the terminal TA are DUZ, X, X, X, X. The value X indicates here that the data or the value transmitted to the corresponding position during the previous dispatch, that is to say during dispatch of the data DT1, are unchanged. This makes it possible to reduce the quantity of data transmitted. During the highlighting step, the terminal TA then highlights on the graph G, the position A of the user UZ, the positions E and C highlighted previously remaining highlighted.

In the embodiment described, the data DT1 are an ordered sequence.

As a variant, an item of position information is associated in the data (DT1, DT2) transmitted to a terminal with each set of data obtained for each user who has signaled his presence. In this embodiment, the list of tag identifiers might not be ordered.

According to a first example, each tag identifier is recorded in the list L in association with a position identifier which represents a position in the graph G and the data DT1 transmitted are a list of pairs in which each pair contains data relating to a user who has signaled his presence and the associated position identifier in the list L.

For example, the position identifiers A, B, C, D, E are recorded respectively in association with the tag identifiers I1, I2, I3, I4 and I5. The data DT1 thus comprise 5 pairs (V, A), (V, B), (DUA, C), (V, D), (DUX, E).

According to a second example, the position identifier is an absolute position value, for example geographical coordinates.

According to a third example, the item of position information is an identifier of at least one neighbor. With reference to the embodiment described previously, the data DT1 would be for example (DUX, IdA), (DUA, IdZ).

In a variant of the embodiment described, the data DT1 are transmitted to one or more terminals only if the number of users who have signaled their presence is greater than or equal to a predefined value, for example 3.

In this variant, in the case where the number of users who have signaled their presence in the environment ENV is less than the predefined value, the item of equipment S dispatches to one or more terminals, in response to the presence signaling notification, an acknowledgment of receipt of the notification or the item of equipment S does not dispatch any response. This makes it possible to limit the number of data messages dispatched (DT1, DT2).

According to a particular embodiment, the data relating to a user, for example the user UA, contained in the data DT1 intended for this user UA, are the identifier of the user UA transmitted in the notification RQA. The terminal TA of the user UA knows the identification data in respect of the user UA or these items of information have been downloaded during an initialization phase. The fact that the data DT1 contain, for the user UA, only the identifier of the user UA makes it possible to reduce the size of the data DT1 to be transferred.

In the embodiment described, the sequences of data DT1, DT2, DT3 comprise an item of information about the unoccupied places.

By way of alternatives, these sequences do not comprise any item of information about the unoccupied places. Each sequence of transmitted data then only makes it possible to position each user in relation to the others on the graph G.

In a particular embodiment, a validity item of information can be recorded for the list L. This validity item of information is for example a time span defined by a start date and an end date.

The items of information relating to the users who have signaled their presence will be erased at the start and/or at the end of the time span.

In the embodiment described previously with reference to FIGS. 1 to 5, the graph G represents positions of users arranged around a table.

No limitation is associated with the disposition of the tags.

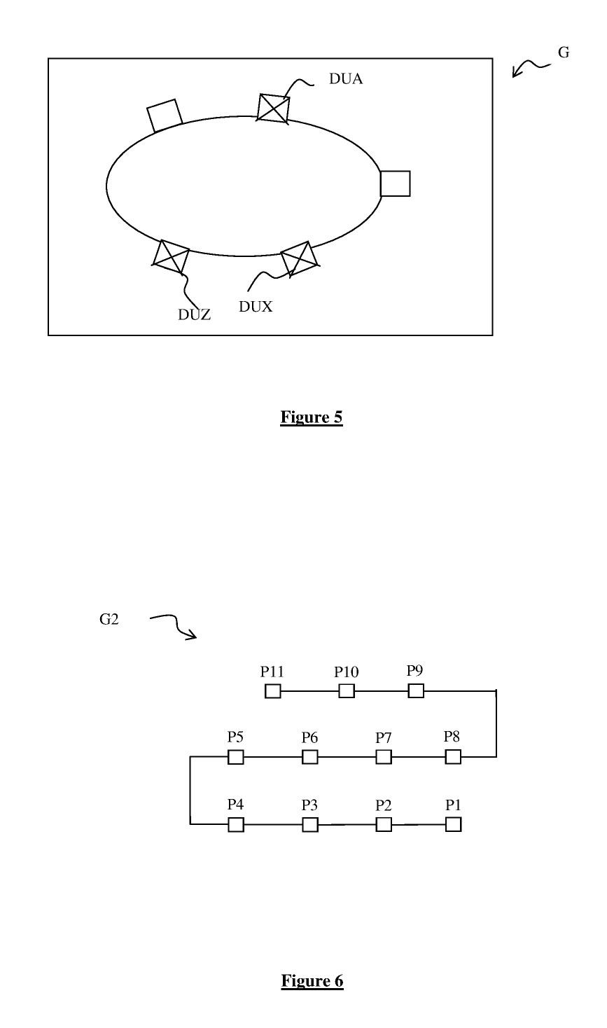

FIG. 6 represents a second exemplary graph G2 representing positions of users in a hall of amphitheater type.

The graph G2 represents positions P1 to P11.

Steps E202, E204, E214, E216, E218, E220, E222, E234, E238, E240, E242 and E250 implemented by the terminal TA, represent steps of a method of obtaining a graph.

Steps E106, E108, E110, E206, E208, E210, E212, E306, E308, E310, E312, E236, E328 and E332 implemented by the item of equipment S, represent steps of a method of presence management.

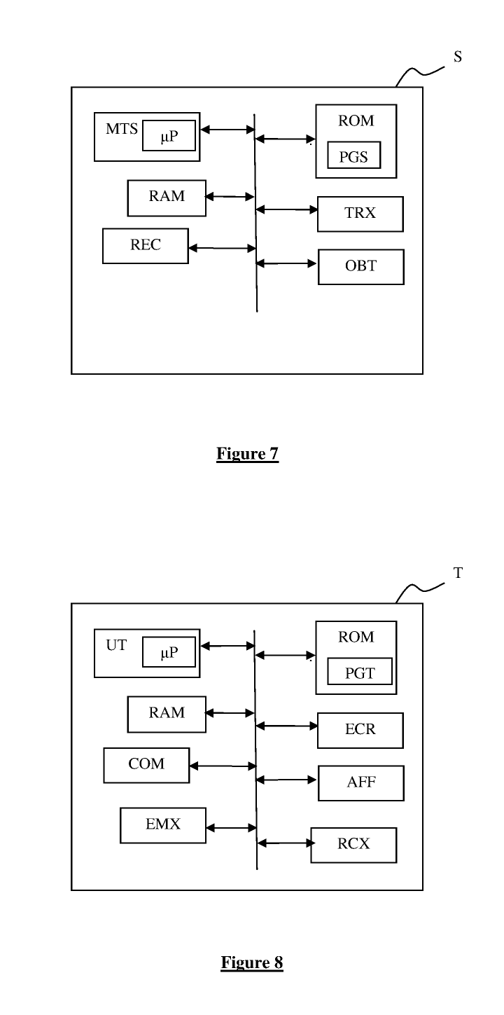

According to a chosen embodiment represented in FIG. 7, an item of equipment implementing a method of presence management according to an exemplary embodiment is for example a server S.

By way of alternative, the item of equipment implementing the method of presence management is a computer of PC (“Personal Computer”) type or a mobile terminal.

The server S comprises in a known manner, notably a processing unit MTS equipped with a microprocessor, a read-only memory of ROM type, a random-access memory of RAM type. The server S can comprise in a conventional and non-exhaustive manner the following elements: a keyboard, a screen, a microphone, a loudspeaker, a communication interface, a storage means, etc.

The read-only memory of ROM type comprises registers storing a computer program PGS comprising program instructions adapted to implement a method of presence management according to one embodiment of the disclosure, described previously with reference to FIG. 2.

The server S also comprises a reception module REC, a transmission module TRX and an obtaining module OBT.

The reception module REC is configured to receive at least one notification emitted by a terminal via a telecommunications network and signaling the presence of a user in a predefined environment, this notification containing on the one hand a medium identifier of a predefined list of medium identifiers for said environment and on the other hand an identifier of the user or of a terminal of the user, this medium identifier being emitted by a data medium able to emit data via a near-field wireless communication technology, the list of medium identifiers containing at least one predefined position information item.

The obtaining module OBT is configured to obtain, for at least one presence notification received, identification data in respect of a user of a terminal targeted in a said notification.

The transmission module TRX is configured to transmit to at least one terminal, via the telecommunication network, data relating to at least one user present in said environment, these data comprising identification data in respect of the user and at least one item of position information.

According to a chosen embodiment represented in FIG. 8, a terminal implementing a graph obtaining method according to an exemplary embodiment is for example a mobile terminal T.

The terminal T comprises in a known manner, notably a processing unit UT equipped with a microprocessor, a read-only memory of ROM type and a random-access memory of RAM type.

The read-only memory of ROM type comprises registers storing a computer program PGT comprising program instructions adapted to implement an obtaining method according to one embodiment of the disclosure, described previously with reference to FIG. 2.

The terminal T can comprise in a conventional and non-exhaustive manner the following elements: a microphone, a loudspeaker, a disk reader, a keyboard, a viewing screen, a display module for display on the viewing screen, a storage means, etc.

The terminal T also comprises a screen ECR, a communication module COM, a reception module RCX, a dispatching module EMX and a display module AFF.

The communication module COM is able to communicate with a data medium by using a near-field wireless communication technology. The communication module COM is designed to obtain a medium identifier when it is situated in the vicinity of a data medium emitting data via a near-field wireless communication technology.

The dispatching module EMX is configured to dispatch to an item of equipment, via a telecommunications network, a notification signaling the presence of a user of the terminal in a predefined environment, said notification containing the medium identifier obtained and an identifier of the user or of the terminal. The dispatching module EMX can also be configured to dispatch destined for said item of equipment a notification signaling the departure of the user from the environment ENV.

The reception module RCX is configured to receive, subsequent to the dispatching of the notification, data emitted by the item of equipment, these emitted data relating to at least one user present in said environment and comprising identification data in respect of at least one user present and at least one item of position information.

The display module AFF is configured to display on the screen ECR, a graph representing positions of users in the predefined environment, to highlight on this graph at least one position allocated to a user as a function of at least one item of position information and to display on this graph, in conjunction with at least one highlighted position, all or part of the data received for this user.

An exemplary embodiment of the present disclosure remedies inadequacies and/or drawbacks of the prior art and/or affords improvements thereto.

Although the present disclosure has been described with reference to one or more examples, workers skilled in the art will recognize that changes may be made in form and detail without departing from the scope of the disclosure and/or the appended claims.

1. A method of obtaining a graph by a telecommunication terminal of a user, said terminal being able to communicate with an item of equipment via a telecommunications network, wherein the method comprises the following acts, implemented by said terminal:
obtaining a medium identifier emitted by a data medium able to emit data via a near-field wireless communication technology, said medium being situated in a predefined environment;
dispatching to said item of equipment a notification signaling the presence of said user in said environment, said notification containing said medium identifier obtained and an identifier of the user or of the terminal;
receiving, subsequent to the dispatching of said notification, from said item of equipment, the data relating to at least one user present in said environment, said data comprising identification data in respect of at least one user present and at least one item of position information;
displaying a graph representing a plurality of positions of users in said environment;
highlighting on said graph at least one position of the plurality of positions, said at least one position being allocated to at least one user of the plurality as a function of said at least one item of position information; and
displaying on said graph, in conjunction with at least one highlighted position, all or part of the data received for at least one user.

2. The method of obtaining according to claim 1, in which said at least one item of position information is an item of relative position information.

3. The method of obtaining according to claim 1, in which the data relating to at least one user present in said environment comprise an ordered sequence of users' identification data.

4. The method of obtaining according to claim 3, in which said sequence contains data signaling at least one unoccupied position.

5. The method of obtaining according to claim 1, in which said at least one item of position information comprises at least one reference to a predetermined position of said graph.

6. The method of obtaining according to claim 1, in which the data relating to at least one user present in said environment comprise a list of pairs, a pair of the list containing identification data in respect of a said user present and a position identifier.

7. The method of obtaining according to claim 1, comprising a step of dispatching to said item of equipment of a notification signaling the departure of said user from said environment, said notification containing an identifier of said user or of said terminal.

8. The method of obtaining according to claim 1, in which the acts of receiving, highlighting and displaying are repeated.

9. A method of presence management comprising the following acts implemented by an item of equipment able to communicate with a plurality of terminals via a communication network:
receiving, from at least one terminal of the plurality, at least one notification signaling the presence of a user in a predefined environment, a said notification containing a medium identifier of a predefined list of medium identifiers for said environment and an identifier of said user or of a terminal of said user, said medium identifier being emitted by a data medium able to emit data via a near-field wireless communication technology, said list of medium identifiers containing at least one predefined position information item;
obtaining, for at least one presence notification received, identification data in respect of said user of said terminal; and
transmitting to said at least one terminal, data relating to at least one user present in said environment, said data comprising said identification data and at least one item of position information.

10. A terminal of a user, said terminal being able to communicate with an item of equipment via a telecommunications network, wherein the terminal comprises:
a near-field communication module configured to obtain a medium identifier emitted by a data medium able to emit data via a near-field wireless communication technology, said medium being situated in a predefined environment;
a module configured to dispatch to said item of equipment a notification signaling the presence of said user in said environment, said notification containing said medium identifier obtained and an identifier of the user or of the terminal;
a module configured to receive, subsequent to the dispatching of said notification, from said item of equipment, data relating to at least one user present in said environment, said data comprising identification data in respect of at least one user present and at least one item of position information; and
a display module configured to:
display a graph representing a plurality of positions of users in said predefined environment;
highlight on said graph at least one position of the plurality of positions, said at least one position being allocated to at least one user of the plurality as a function of said at least one item of position information; and
display on said graph, in conjunction with at least one highlighted position, all or part of the data received for at least one user.

11. An item of equipment able to communicate with a plurality of terminals via a communication network comprising:
a reception module configured to receive, from at least one terminal of the plurality, of at least one notification signaling the presence of a user in a predefined environment, a said notification containing a medium identifier of a predefined list of medium identifiers for said environment and an identifier of said user or of a terminal of said user, said medium identifier being emitted by a data medium able to emit data via a near-field wireless communication technology, said list of medium identifiers containing at least one predefined position information item;
an obtaining module configured to obtain, for at least one presence notification received, identification data in respect of said user of said terminal; and
a transmission module configured to transmit to said at least one terminal, the data relating to at least one user present in said environment, said data comprising said identification data and at least one item of position information.

12. (canceled)

13. (canceled)

14. (canceled)
